(19) United States
(12) Patent Application Publication
(10) Pub. No.: US 2007/0097270 A1
(43) Pub. Date: May 3, 2007

(54) Multiple TV signal processor

(75) Inventor: Yu-Chiang Shih, Taipei Hsien (TW)

Correspondence Address: BIRCH STEWART KOLASCH & BIRCH, PO BOX 747, FALLS CHURCH, VA, 22040-0747, US

(73) Assignee: ANIMATION TECHNOLOGIES INC.

(21) Appl. No.: 11/580,016

(22) Filed: Oct. 13, 2006

(30) Foreign Application Priority Data
Oct. 28, 2005 (TW) 094218707

(51) Int. Cl. H04N 3/27; H04N 5/268

(52) U.S. Cl. 348/705; 348/554

(57) ABSTRACT

A multiple TV signal processor is disclosed. The multiple TV signal processor comprises a plurality of signal receiver, a signal-processing module, a decoder and a transmission interface. The signal receivers are adopted for receiving and transmitting external TV signals. The signal-processing module is electrically connected to the signal receivers and is adopted for receiving and demodulating the TV signals transmitted from the signal receivers. The decoder is electrically connected to the signal-processing module and is adopted for receiving and decoding the demodulated TV signals from the signal-processing module. The transmission interface is electrically connected to the decoder and is adopted for transmitting the TV signals decoded by the decoder to a host end.

### BACKGROUND OF THE INVENTION

1. Field of the Invention

The present invention generally relates to a multiple TV signal processor (a “signal processor” is commonly known as a “tuner”, EX: “multiple TV tuner”; the term “signal processor” will be used for the purposes of this document), and more particularly to a multiple TV signal processor capable of simultaneously receiving analog TV signals and digital TV signals and capable of playing a plurality of TV programs.

2. Description of the Related Art

The history of the TV set entails from the early black and white TV, to the color TV, and to the latest LCD TVs and plasma TVs. TV display quality nowadays is of high quality, with excellent contrast and bright color. Available TV channels also range from a few channels to more than a hundred channels. The method of TV signal transmission is soon going to be upgraded to digital TV signals.

The latest TV signal displaying method, regardless of analog or digital format, is implemented only in one particular scheme; for example, a TV monitor is connected to a signal receiver and a signal transmission wire for receiving images and sound information and for display/playback of these images and sounds. A computer monitor connects to a computer in order to display video and image output by the computer. Thanks to the rapid development of technology, computer monitors may be used in different ways. The computer may receive signals from a remote location through the Internet, and may be connected to a web camera for obtaining a video connection to display images captured at the remote location. Aside from connecting the computer monitor to the computer for remote video transmission, the computer monitor may also be used as a TV monitor, and thus the application of the computer monitor can be broader than ever. However, the designs of computers and TVs are different, and the methods of receiving, transmitting and playing back the audio-video signal are also different. Therefore, a TV box or TV card is required for viewing TV programs on a computer monitor. In other words, only when the TV signal is converted into a signal in a format acceptable to the computer, may the user be able to view the TV program on the computer monitor.

Therefore, a way to simultaneously receive analog and digital TV signals for playing a plurality of TV programs on the computer monitor is an important issue for manufacturers in the field.

### SUMMARY OF THE INVENTION

According to an aspect of the present invention, the signal-processing module comprises a plurality of signal processors for demodulating TV signals and transmitting the demodulated TV signals to a decoder for decoding. Next, the decoded TV signals are transmitted to a host end for playing via a transmission interface. Thus, a plurality of analog and digital TV programs may be played simultaneously.

### BRIEF DESCRIPTION OF THE DRAWING

FIG. 1 is a block diagram of a multiple TV signal processor according to an embodiment of the present invention.

FIG. 2 is a block diagram of a multiple TV signal processor according to a first embodiment of the present invention.

FIG. 3 is a block diagram of a multiple TV signal processor according to a second embodiment of the present invention.

FIG. 4 is a block diagram of a multiple TV signal processor according to a third embodiment of the present invention.

FIG. 5 is a block diagram of a multiple TV signal processor according to a fourth embodiment of the present invention.

### DETAILED DESCRIPTION OF THE INVENTION

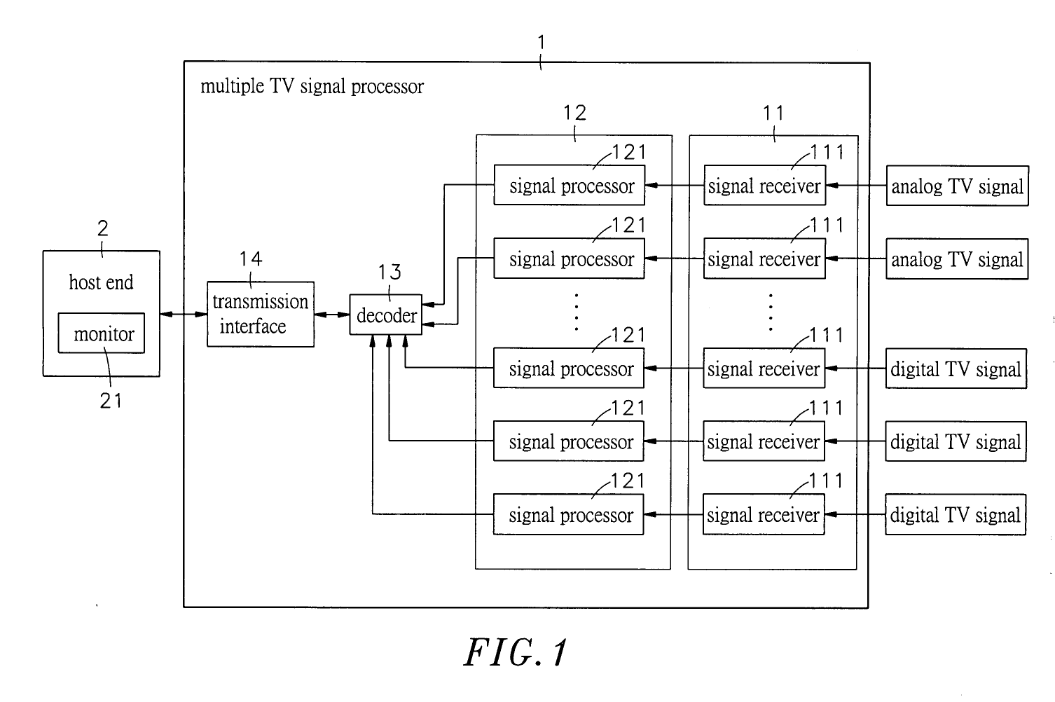

Referring to FIG. 1, a multiple TV signal processor 1 of the present invention comprises of a signal-receiving module 11, a signal-processing module 12, a decoder 13 and a transmission interface 14.

The signal-receiving module 11 comprises a plurality of signal receivers 111 for receiving external TV signals. The external TV signals can be digital TV signals or analog TV signals.

The signal-processing module 12 comprises a plurality of signal processors 121 which are electrically connected to the signal receivers 111 respectively. The signal-processing module 12 is adopted for receiving and demodulating the TV signals transmitted from the signal receivers 111.

The decoder 13 is electrically connected to the signal-processing module 12. The decoder 13 is adopted for receiving and decoding the demodulated TV signals transmitted from the signal-processing module 12.

The transmission interface 14 is electrically connected to the decoder 13, and is adopted for transmitting the TV signals decoded by the decoder 13 to a host end 2.

The external TV signals may be digital TV signals comprised of DVB-T, DVB-C, DVB-H, DVB-S, ATSC, ISDB-T, DMB-T or analog TV signals. The TV signals mentioned above are merely for the purpose of illustrating the embodiment of the present invention and are not intended for limiting the scope of the present invention. Accordingly, any equivalent signals may also be used to achieve the purpose of the present invention and shall be construed to be within scope of the present invention.

When the multiple TV signal processor 1 is electrically connected to the host 2 through the transmission interface 14, the signal receivers 111 receive external TV signals respectively, the TV signals are transmitted to the signal-processing module 12 via carriers, and then the carriers are separated from the TV signals. After separating the carrier, the TV signals are still in a signal transmission mode that needs to be converted by the decoder 13 into a digital multimedia playing format or digital multimedia streaming image format, and then transmitted to the host end 2 through the transmission interface 14. Thus, the host end 2 can display analog and digital TV programs on a monitor 21 for a user to view. The host end 2 can also simultaneously display a plurality of analog and digital TV programs. When the user views one TV program, other TV programs may be viewed at the same time. Thus, the user may watch one TV program without missing another TV program also playing at that time.

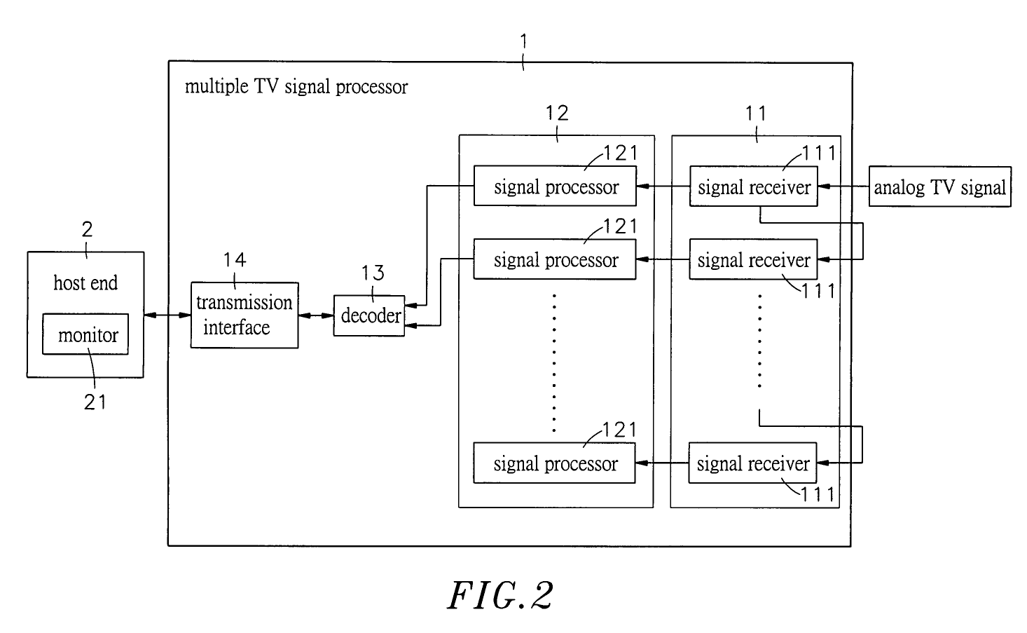

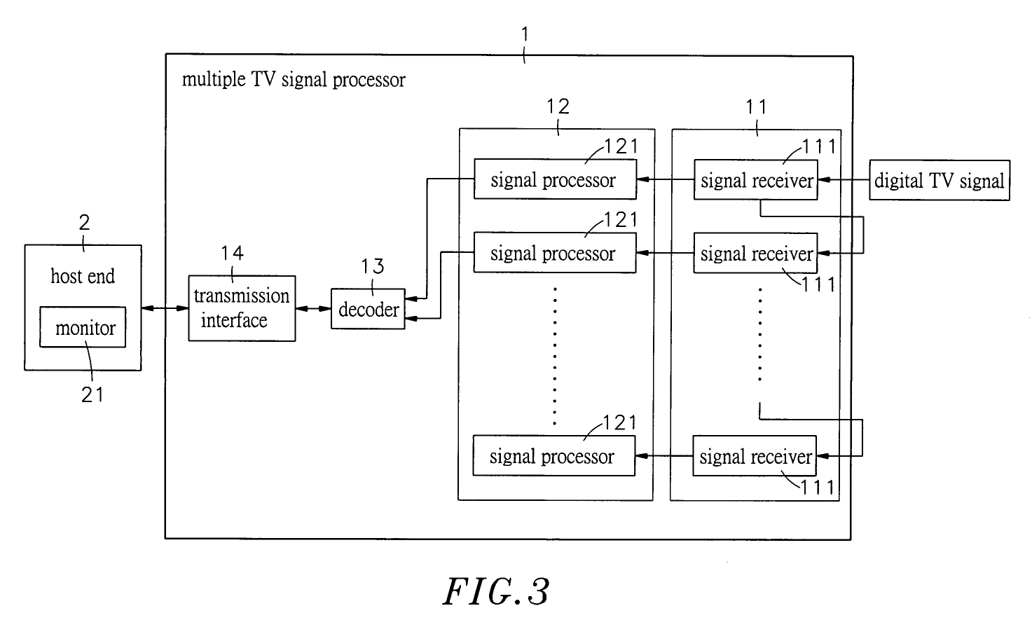

Referring to FIGS. 2 and 3, a multiple TV signal processor 1 comprises a signal-receiving module 11, a signal-processing module 12, a decoder 13 and a transmission interface 14.

The signal-receiving module 11 comprises a plurality of signal receivers 111. The signal-receiving module 11 is adopted for receiving external TV signals through one signal receiver 111 and transmitting the received TV signals to other signal receivers 111. The external TV signals can be digital TV signals or analog TV signals.

The signal-processing module 12 comprises a plurality of signal processors 121 which are electrically connected to the signal receivers 111 respectively. The signal-processing module 12 is adopted for receiving and demodulating the TV signals transmitted from the signal receivers 111.

The decoder 13 is electrically connected to the signal-processing module 12. The decoder 13 is adopted for receiving and decoding the modulated TV signal transmitted from the signal-processing module 12.

The transmission interface 14 is electrically connected to the decoder 13, and is adopted for transmitting the TV signal decoded by the decoder 13 to a host end 2.

The external TV signals may be digital TV signals comprising DVB-T, DVB-C, DVB-H, DVB-S, ATSC, ISDB-T, DMB-T or analog TV signals. The TV signals mentioned above are merely used for the purpose of illustrating the embodiment of the present invention and are not intended for limiting the scope of the present invention. Accordingly, any equivalent signal may be used to achieve the purpose of the present invention and shall be construed to be within the scope of the present invention.

When the multiple TV signal processor 1 is electrically connected to the host end 2 through the transmission interface 14, the signal-receiving module 11 receives a TV signal through one signal receiver 111 and then transmits the TV signal to other signal receivers 111. The process of demodulating the TV signal by the signal-processing module 12 and the process of decoding the demodulated TV signal by the decoder 13 are identical to those described above, and therefore will not be repeated. Thus, the multiple TV signal processor 1 of the present invention only needs to receive one TV signal to enable a user to view a plurality of analog and digital TV programs. When the user views one TV program, other TV programs may also be viewed at the same time. Thus, the user may watch one TV program without missing another TV program also playing at that time.

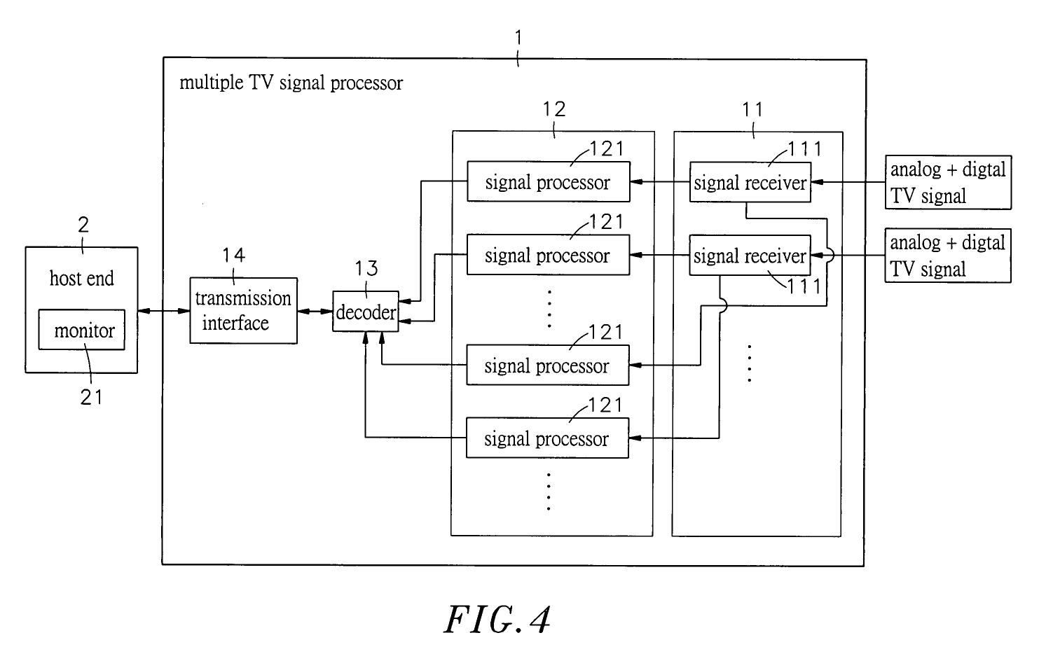

Referring to FIG. 4, when the external TV signals are analog terrestrial broadcast and digital terrestrial broadcast, the signals can be received by the same signal receiver 111 and then respectively transmitted to the signal processor 121 for demodulating in order to enable the user to view the analog and digital TV programs on the monitor 21 of the host end 2. The host end 2 also comprises software for facilitating the user to switch between analog TV programs and digital TV programs.

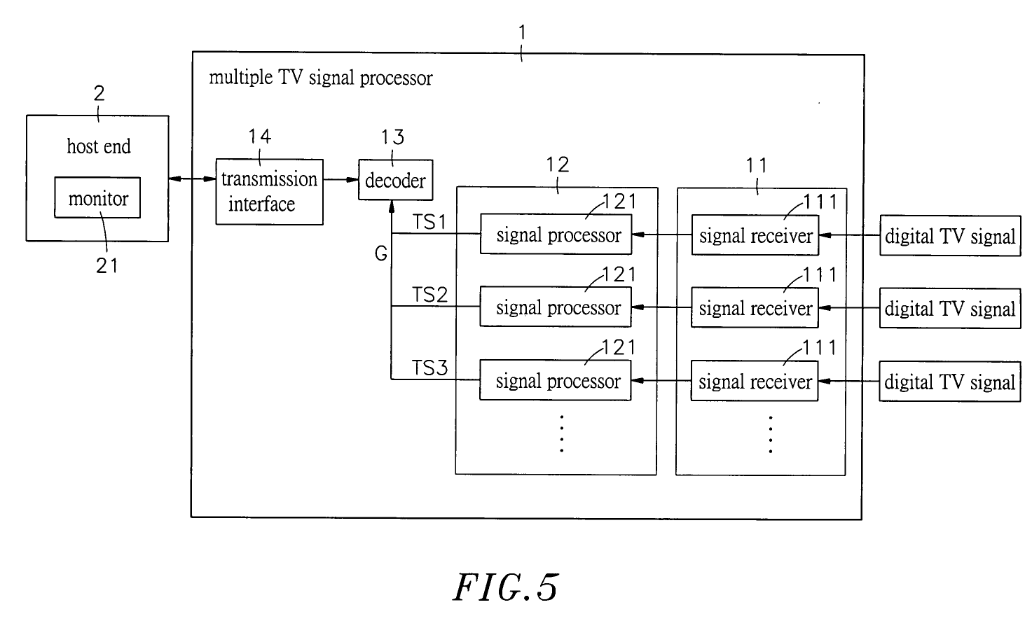

Referring to FIG. 5, when the multiple TV signal processor 1 receives external TV signals via the signal receivers 111, the TV signals in the same or different mode are demodulated by the signal-processing module 12, and the demodulated TV signals, for example TS1, TS2, TS3 and so on, are transmitted to the decoder 13 for decoding in parallel. These signals may be digital TV signals comprising DVB-T, DVB-C, DVB-H, DVB-S, ATSC, ISDB-T or DMB-T TV signals. The TV signals mentioned above are merely used for the purpose of illustrating the embodiment of the present invention and are not intended for limiting the scope of the present invention. Thus, the user may switch between a plurality of TV signals of different types for display on the monitor 21 of the hose end 2.

The above transmission interface 14 can be of the PCI, MINI-PCI, MINI-CARD, PCMCIA, PCI-EXPRESS or USB standard. The transmission interface 14 between the multiple TV signal processor 1 and the host end 2 described above is merely used for demonstrating the embodiment of the present invention and is not intended for limiting the scope of the present invention. Accordingly, any equivalent device may also be used for achieving the purpose of the present invention and shall be construed to be within the scope of the present invention.

Furthermore, the above signal processor 121 can be a single chip processor, a multiple chip processor, a digital signal processor, an analog signal processor or a signal processor for demodulating. The above description is merely used for demonstrating the embodiment of the present invention and is not intended for limiting the scope of the invention. Accordingly, any equivalent devices or components may be used for achieving the purpose of the present invention and shall be construed to be within the scope of the present invention.

Accordingly, the multiple TV signal processor 1 of the present invention has at least the following advantages.

1. A plurality of signal receivers 111 of the present invention are adopted for receiving external TV signals, and the external TV signals are demodulated by a signal-processing module 12 and then decoded by a decoder 13 and transmitted to a host end 2 through a transmission interface 14 for playing analog and digital TV programs on a monitor 21. Furthermore, the host end 2 may also simultaneously play the analog and digital TV programs. Thus, when the user views one TV program, the user may also view other TV programs at the same time. Thus, the user may watch one TV program without missing another TV program also playing at that time.

2. The signal-receiving module 11 of the present invention uses one signal receiver 111 to receive the external TV signals and transmit to other signal receivers 11, and then the TV signals are demodulated by a signal-processing module 12 and decoded by a decoder 13 and transmitted to a host end 2 through a transmission interface 14 for playing on a monitor 21 of the host end 2. In addition, the host end 2 may also simultaneously display analog and digital TV programs.

3. The plurality of signal receivers 111 of the present invention can receive the external TV signals and the TV signals in the same or different modes are demodulated by the signal-processing module 12, and the modulated TV signals are transmitted to the decoder 13 for decoding. Thus, the user may use software in the host end 2 to switch the programs.

While the invention has been described in conjunction with a specific suggested mode of use/operation, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A multiple TV signal processor, comprising:
a plurality of signal receivers, for receiving and transmitting external TV signals;
a signal-processing module, electrically connected to said signal receivers, for receiving and demodulating said TV signals transmitted from said signal receivers;
a decoder, electrically connected to said signal-processing module, for receiving and decoding said demodulated TV signals from said signal-processing module; and
a transmission interface, electrically connected to said decoder, for transmitting said TV signals decoded by said decoder to a host end.

2. A multiple TV signal processor, comprising:
a signal-receiving module, comprising of a plurality of signal receivers, for receiving external TV signals via one of said signal receivers and transmitting said TV signals to other of said signal receivers;
a signal-processing module, respectively electrically connected to said signal receivers, for receiving and demodulating said TV signals transmitted from said signal receivers;
a decoder, electrically connected to said signal-processing module, for receiving and decoding said demodulated TV signals from said signal-processing module; and
a transmission interface, electrically connected to said decoder, for transmitting said TV signals decoded by said decoder to a host end.

3. The multiple TV signal processor according to claim 1, wherein said external TV signals can be digital TV signals comprised of DVB-T, DVB-C, DVB-H, DVB-S, ATSC, ISDB-T and DMB-T or analog TV signals.

4. The multiple TV signal processor according to claim 1, wherein said signal receivers can be radio frequency wireless receivers or coaxial cable connectors.

5. The multiple TV signal processor according to claim 1, wherein said signal processor can be a digital signal processor, an analog signal processor or a signal processor with a demodulating function.

6. The multiple TV signal processor according to claim 1, wherein said signal processor can be a single chip processor or a multiple chip processor.

7. The multiple TV signal processor according to claim 1, wherein said transmission interface can be of the PCI, MINI-PCI, MINI-CARD, PCMCIA, PCI-EXPRESS or USB standard.

8. The multiple TV signal processor according to claim 2, wherein said external TV signals can be digital TV signals comprised of DVB-T, DVB-C, DVB-H, DVB-S, ATSC, ISDB-T and DMB-T or analog TV signals.

9. The multiple TV signal processor according to claim 2, wherein said signal receivers can be radio frequency wireless receivers or coaxial cable connectors.

10. The multiple TV signal processor according to claim 2, wherein said signal processor can be a digital signal processor, an analog signal processor or a signal processor with a demodulating function.

11. The multiple TV signal processor according to claim 2, wherein said signal processor can be a single chip processor or a multiple chip processor.

12. The multiple TV signal processor according to claim 2, wherein said transmission interface can be of the PCI, MINI-CARD, PCMCIA, PCI-EXPRESS or USB standard.
